(19) United States
(12) Patent Application Publication
(10) Pub. No.: US 2024/0062328 A1
(43) Pub. Date: Feb. 22, 2024

(54) HYPER-PERSONALIZED FEATURE MORPHING IN METAVERSE

(71) Applicant: International Business Machines Corporation, Armonk, NY (US)

(72) Inventors: Shikhar Kwatra, San Jose, CA (US); Kavitha Hassan Yogaraj, Bangalore (IN); Tiberiu Suto, Franklin, NY (US); Vinod A. Valecha, Pune (IN)

(21) Appl. No.: 17/820,587

(22) Filed: Aug. 18, 2022

(51) Int. Cl. G06T 3/00

(52) U.S. Cl. CPC G06T 3/0093

(57) ABSTRACT

Aspects of the invention include systems and methods configured for hyper-personalized feature morphing of an avatar within a metaverse. A non-limiting example computer-implemented method includes predicting a next interaction for the avatar and comparing one or more current features of the avatar to one or more feature requirements for the predicted next interaction. The method further includes determining, based on the comparison, that one or more current features of the avatar do not match one or more feature requirements for the predicted next interaction. Responsive to the determination, features of the avatar are altered to satisfy the one or more feature requirements for the predicted next interaction.

### BACKGROUND

The present invention generally relates to metaverse applications, and more specifically, to computer systems, computer-implemented methods, and computer program products for hyper-personalized feature morphing within a metaverse.

The term metaverse is widely used to describe a fully immersive virtual space, which includes a simulated environment where humans are represented by an avatar. Each avatar is a representation of a user of the metaverse, and generally takes the form of a two-dimensional or three-dimensional human or fantastical representation of a person's self. Users can inhabit, traverse, and interact with objects and other users, both socially and economically, through their respective avatars within the metaverse. In some cases, the virtual environment in a metaverse is built upon a metaphor of the real world, but in most cases, without the physical limitations of the real world.

A metaverse can be a two-dimensional or three-dimensional virtual world formed as electronic data and can include aspects of virtual reality, augmented reality, and mixed reality technologies. Virtual reality refers to technologies that construct a virtual space that does not exist in the real world, and then make the virtual space feel real. Augmented reality and mixed reality technology are technologies that blend the virtual space with the real world, often by superimposing virtual information over a person's field of view, that is, they are technologies that combine the real world with the virtual world to enable seamless integration between those spaces.

### SUMMARY

Embodiments of the present invention are directed to hyper-personalized feature morphing of an avatar within a metaverse. A non-limiting example method includes predicting a next interaction for the avatar and comparing one or more current features of the avatar to one or more feature requirements for the predicted next interaction. The method further includes determining, based on the comparison, that one or more current features of the avatar do not match one or more feature requirements for the predicted next interaction. Responsive to the determination, features of the avatar are altered to satisfy the one or more feature requirements for the predicted next interaction.

Other embodiments of the present invention implement features of the above-described method in computer systems and computer program products.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a block diagram of an example computing environment for use in conjunction with one or more embodiments of the present invention;

FIG. 2 depicts a block diagram of an example hyper-personalized feature morphing system for use in conjunction with one or more embodiments of the present invention;

FIG. 3 depicts an example representation illustrating dynamic hyper-personalized feature morphing in accordance with one or more embodiments of the present invention;

FIG. 4 depicts a block diagram for hyper-personalizing an avatar in accordance with one or more embodiments of the present invention;

FIG. 5 depicts a diagram for determining geospatial distancing within a metaverse in accordance with one or more embodiments of the present invention; and

FIG. 6 is a flowchart in accordance with one or more embodiments of the present invention.

### DETAILED DESCRIPTION

As discussed above, a metaverse is a virtual, simulated world or environment within which users can inhabit, traverse, and interact, socially and economically, via avatars. In some cases, real-world interactions, such as a meeting, can be held wholly or partially within a metaverse. Shifting some portion of real-world interactions and events to a metaverse offers a number of benefits, such as greatly increasing access and flexibility beyond that achievable for real-world interactions or events. For example, a business meeting that is typically held in person can be held instead within a metaverse, allowing employees to participate from almost anywhere in the world. Moreover, those employees can interact, via their avatars, in a safe manner regardless of the medical status (e.g., illness, etc.) of each avatar's user.

There are many challenges, however, in streamlining the metaverse experience. The value of face-to-face interactions will likely never go away, and finding new ways in which a metaverse can better mimic or otherwise replicate the quality of in-person interactions is of great interest. For example, how would one turn a multi-day conference, filled with networking opportunities, educational sessions, and the attendee insights they generate, into successful virtual events?

One approach to improve interactions (engagement) within a metaverse is to make those interactions as real-like as possible. In particular, current metaverse applications allow users to personalize their avatar across an increasingly varied feature space. In some cases, users can achieve almost photo-realism with their avatars, allowing seamless, natural interactions (e.g., conversations) between users. Similarly, users can outfit or otherwise decorate their avatars using a myriad of options to truly customize the look and feel of their avatar. Unfortunately, these customizations are typically applied in an almost ad-hoc manner, such as during the initial avatar configuration. These types of limitations in personalization tend to reduce engagement within a metaverse.

One or more embodiments of the present invention address one or more of the above-described shortcomings by providing computer-implemented methods, computing systems, and computer program products for hyper-personalized feature morphing within a metaverse. Embodiments of the present invention leverage hyper-personalization (e.g., dynamic attire generation) for avatars to create a more immersive metaverse experience. An avatar's appearance can be dynamically changed based on multi-factor criteria, such as current or anticipated engagement with a particular avatar(s), object(s), and/or virtual event(s). The hyper-personalized feature morphing of an avatar can be optimized for business interactions in diverse virtual environment scenarios. For example, approaching a location for an interview with a specific business entity can trigger an avatar's clothing to change from a casual piece (e.g., shirt and shorts) to formal attire (e.g., a suit).

In some embodiments, hyper-personalized feature morphing is triggered in response to rules and/or preferences for the avatar. The rules and/or preferences can be defined by a user, or advantageously, learned (in whole or in part) by a predictive model through observations of interactions with the avatar and other avatars, locations, and objects. In some embodiments, dynamic feedback from the avatar's user (e.g., altering the appearance/attire of the avatar before or after a dynamically applied hyper-personalized feature morphing is triggered) can be tracked and provided as new input data to the learning model.

In some embodiments, a hyper-personalization system configured for dynamic feature morphing makes a prediction regarding the user's next interaction. The next interaction can be inferred, for example, by observing a gaze direction, trajectory, and/or proximity of the user's avatar to one or more other avatars, objects, and/or locations within the metaverse. Once the prediction for the next interaction is known, the hyper-personalization system can determine and dynamically apply an appropriate personalization to the avatar.

Advantageously, hyper-personalization systems and techniques of the present disclosure tend to increase realism (e.g., the quality, appropriateness, etc. of various interactions), and thus engagement, within a metaverse. Through hyper-personalization, meeting attendees within a metaverse can be highly contextualized to the specific company event they are attending, the particular place they are currently located, the current time (either virtual or real-world), etc. Virtual attendants of a conference can, for example, be dynamically altered to match the context of the various informational booths that the user's avatar moves between.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

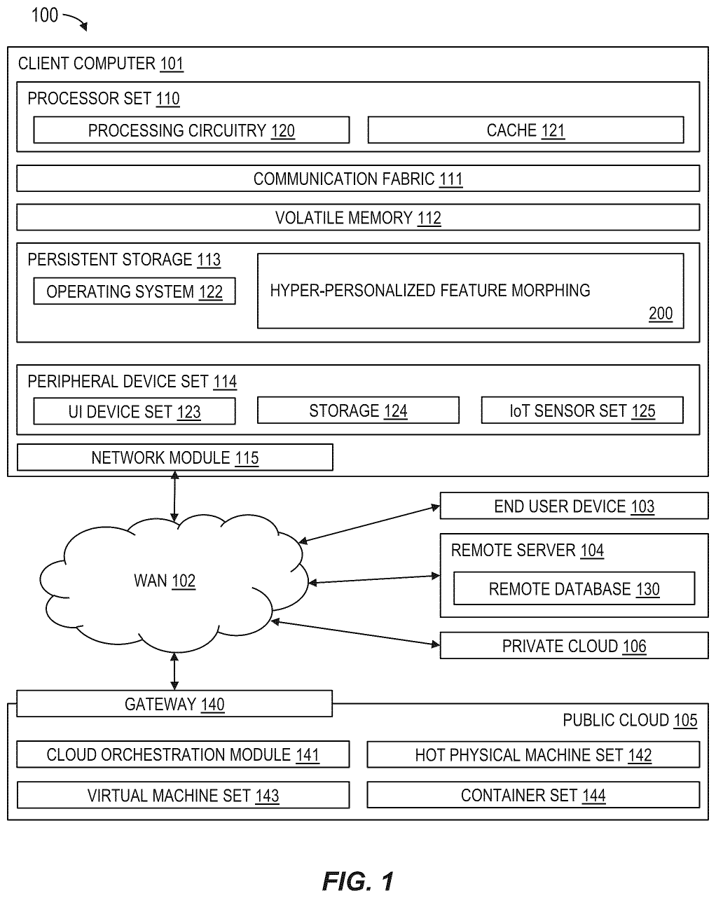

Referring now to FIG. 1, computing environment 100 contains an example of an environment for the execution of at least some of the computer code involved in performing the inventive methods, such as hyper-personalized feature morphing 200 (referred to herein as block 200). In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

It is to be understood that the block diagram of FIG. 1 is not intended to indicate that the computing environment 100 is to include all of the components shown in FIG. 1. Rather, the computing environment 100 can include any appropriate fewer or additional components not illustrated in FIG. 1 (e.g., additional memory components, embedded controllers, modules, additional network interfaces, etc.). Further, the embodiments described herein with respect to the computing environment 100 may be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

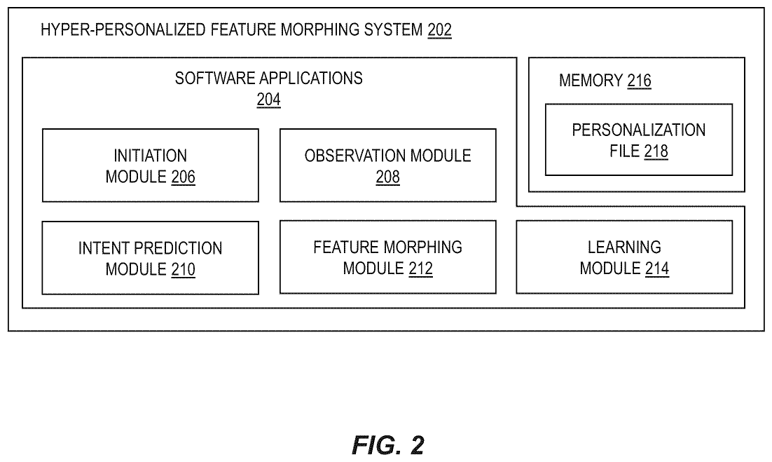

Referring now to FIG. 2, a block diagram of a hyper-personalized feature morphing system 202 for use in conjunction with one or more embodiments of the present invention is shown. In some embodiments, the hyper-personalized feature morphing system 202 can include or by implemented by (in whole or in part) one or more processors (e.g., the computing environment 100 of FIG. 1). In other words, any number of elements of the computing environment 100 of FIG. 1 may be used in and/or integrated into the hyper-personalized feature morphing system 202. The hyper-personalized feature morphing system 202 can include software applications 204, including an initiation module 206, an observation module 208, an intent prediction module 210, a feature morphing module 212, and a learning module 214, although other components and subsystems are within the contemplated scope of the disclosure. The software applications 204 may utilize and/or be implemented as software executed on one or more processors (e.g., the computing environment 100 of FIG. 1). The hyper-personalized feature morphing system 202 can further include memory 216 storing a personalization file 218. The memory 216 can be local memory or external memory, such as that provided by a private or public cloud computing environment (see FIG. 1).

In some embodiments, the initiation module 206 is configured to initialize a user's avatar upon entering a metaverse. In some embodiments, avatar initialization includes setting, selecting, or otherwise defining one or more default features for the avatar. Features can include, for example, attire (e.g., clothing, accessories, etc.) and body characteristics (e.g., eye color, face shape, nose angle and position, height, size, etc.), or any other configurable parameter of avatars in the respective metaverse. The specific features are illustrative only and are not meant to be particularly limited.

In some embodiments, a user can define one or more default features for their avatar. These default features can be stored, for example, in memory 216 as a personalization file 218 that can be retrieved responsive to the avatar entering the metaverse (e.g., during login). The default features can capture a user's primary attire selection for their avatar, their default location, and additional appearance and personalization features and preference for the user's avatar. In some embodiments, a user can opt into hyper-personalization by setting up a user profile having default features within the hyper-personalized feature morphing system 202.

In some embodiments, users can purchase or rent features, such as virtual outfits and accessories, for their avatars. In some embodiments, users can designate subsets of available features (i.e., free, owned, or rented features) for specific use types. For example, subsets of features can be allocated or otherwise tagged for use as business formal wear, business casual wear, daytime or evening event wear, etc.).

In some embodiments, a user can designate a preferred/favorite storefront(s) (virtual or otherwise) for purchasing features (e.g., new attire). In some embodiments, preferred storefronts are associated with a location or region, within which the avatar must be before the hyper-personalized feature morphing system 202 will utilize the storefront for purchases. For example, the avatar can approach a storefront as it moves through the metaverse. Once within a predetermined threshold proximity, the hyper-personalized feature morphing system 202 can access the storefront to make purchases based on, for example, the preferences or requirements of the user. Learning the preferences or requirements of the user is discussed in further detail below with respect to the learning module 214.

In some embodiments, a user can select preferred outfit(s), accessories, etc. for interactions with specific avatars or entities (e.g., a specific companies' booth, representatives, or attendees at a virtual conference). For example, an attorney may want to outfit their avatar with a formal suit when interacting with another attorney from a different firm at the conference but may choose a more casual polo shirt and slacks outfit to attend a presentation session from a software company. Similarly, t-shirt and jeans can be preferred when joining a friend for virtual lunch conversation.

In some embodiments, the observation module 208 is configured to monitor or otherwise track the avatar of the user as it traverses through the metaverse. The observation module 208 can track the avatar's location using known processes, such as via a private or shared coordinate system within the metaverse (or local to the hyper-personalized feature morphing system 202) and/or via movement logging of the avatar. The particular means for monitoring the avatar are not meant to be particularly limited and the observation module 208 can be configured with any of a variety of monitoring procedures for tracking the avatar.

In some embodiments, the observation module 208 is configured to extract or otherwise capture moments of interest (e.g., highlights from the virtual event) for the user. Moments of interest can be determined based on, for example, a user's engagement with different avatars, objects (including, e.g., interactions with said objects), and locations (e.g., a virtual conference booth). Highlights can include images, video, audio data, etc. captured within the metaverse. In some embodiments, the observation module 208 is configured to store these highlights in the personalization file 218.

In some embodiments, the intent prediction module 210 is configured to cognitively determine (predict) the user's intent and/or a next interaction (collectively referred to as intent prediction). Interactions can include, for example, avatar-to-avatar interactions (e.g., interactions with another user(s) in the metaverse) as well as object (e.g., picking up an object), location (e.g., visiting a particular zone with the metaverse), and event (e.g., entering a virtual conference booth, beginning a virtual interview, etc.) interactions. For example, as a user navigates their avatar around a virtual conference, the intent prediction module 210 can predict which booth or attendees the user is most likely to interact with next.

Intent prediction can be based on a compilation of evidence, such as, for example, a gaze direction of the avatar (e.g., which booth, object, area, avatar, etc., collectively referred to as a prediction target, is the user's avatar currently looking at or towards?), a gaze duration (e.g., how long has the avatar been looking at the prediction target?), proximity (e.g., how close is the avatar to the prediction target?), trajectory (e.g., is the avatar moving towards or in the direction of the prediction target?), predetermined or user-defined prediction targets (e.g., has the user specified that a particular interaction is expected to occur, or is desirable?), learned behavior of the user (e.g., does the user typically interact with the prediction target when within the current proximity, gaze duration, etc.?), and/or mined data about the user and/or the prediction target (e.g., mining the user's email, social media, and/or calendar using natural language processing to discover an upcoming interview within the metaverse).

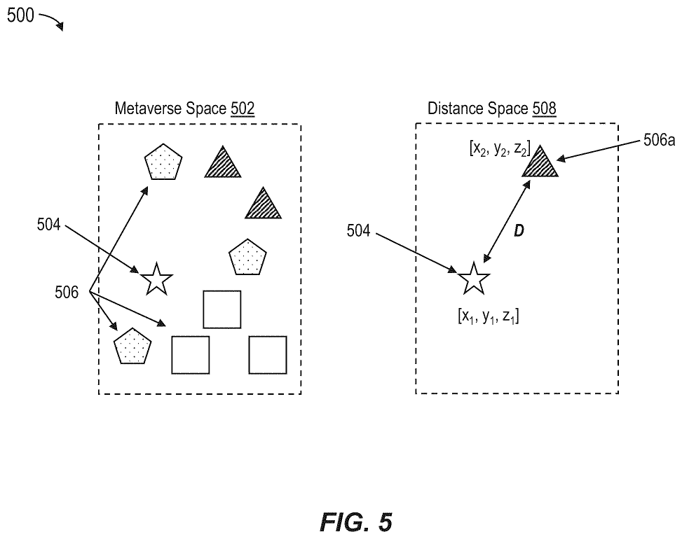

In some embodiments, intent is inferred by proximity computed using a Euclidean/Manhattan distance. For example, intent to visit a particular virtual booth and/or metaverse sub-space within a virtual event can be computed based on the Euclidean/Manhattan distance between the avatar and the predicted target in that geospatial environment. The use of Euclidean/Manhattan distance determinations is discussed in greater detail below with respect to FIG. 5. In some embodiments, prediction targets are selected from a plurality of possible targets based in part on proximity. For example, the proximity to different virtual booths and/or sub-spaces within the virtual event can be computed (e.g., geospatial distance, Euclidean/Manhattan distance) and the N closest possible targets are defined as prediction targets. In some embodiments, the N closest possible targets change dynamically in response to movements of the avatar.

In some embodiments, intent is inferred by weighting the relative importance of the combination of evidence. For example, intent to visit a particular booth can be inferred when the geospatial distance to the respective booth is below a predetermined threshold and the avatar is moving closer to the respective booth. In some embodiments, the relative importance of the various factors is determined by setting the weights of a learning model, such as, for example, a neural network.

As discussed previously, the intent prediction module 210 can be configured to mine (or scrape) data about the user and/or the prediction target. In some embodiments, the intent prediction module 210 is configured to scan a user's email, social media, calendar, chat messages, etc., using natural language processing, to determine a future intention of the user/avatar. For example, consider a scenario where a user sends an email message to a CEO of company X that states, “See you at the conference! I would like to talk to you more about my qualifications for the database architect opening at your company.” In some embodiments, the intent prediction module 210 can determine that the user has the intent of applying for a position at company X.

Similarly, the intent prediction module 210 can determine which, if any, other participants anticipated to be at the conference (via, e.g., calendar data, invitation data, etc.) are known to the user. In some embodiments, the type of relationship (formal, friends, coworkers, etc.) can be inferred by the tone and content of messages, emails, and other interactions (jokes, humor, etc.) between the user and the respective participant. This data can be collected using data mining and natural language processing in a similar manner as previously described. In some embodiments, the known participants and their inferred relationship to the user is provided as evidentiary input to the intent prediction module 210.

In some embodiments, the feature morphing module 212 is configured to dynamically change one or more configurable features of the user's avatar. In some embodiments, the feature morphing module 212 (and/or the learning module 214, discussed in greater detail below) is configured to determine an appropriate set of features for an upcoming interaction, based on a prediction target determined by the intent prediction module 210.

Continuing with an earlier example, consider the scenario where a user sends an email message to a CEO of company X that states, “See you at the conference! I would like to talk to you more about my qualifications for the database architect opening at your company.” In some embodiments, the feature morphing module 212, responsive to the intent prediction module 210 determining that the user has the intent to apply for a position at company X, can determine that the proper outfit for such an interaction (e.g., an interview) is formal business attire. Once the user enters the metaverse and approaches a representative of company X, the feature morphing module 212 can automatically apply the proper outfit (here, a suit for a job interview) before the participants virtually meet each other. Similarly, if an impending interaction is with a friend, coworker, etc., the feature morphing module 212 can choose a more appropriate attire for those interactions as well (e.g., casual wear for friends, business casual for coworkers, etc.). In other words, the feature morphing module 212 can, based on who/what the avatar will likely be interacting with next, prepare the avatar via feature morphing (e.g., changing an outfit) to a set of features that are optimal or otherwise desired for that interaction.

In some embodiments, the feature morphing module 212 applies one or more custom or learned attire rules and/or preferences to select features for the user's avatar. In some embodiments, the feature morphing module 212 overlaps features (e.g., outfits) onto or over the user's avatar using mesh and or pixel morphing techniques. For example, an outfit overlay can be built over and fixed to the avatar by tracking the avatar's coordinates in the 2D or 3D space and using a generative network with arbitrarily fine resolution (e.g., a GAN that affects color scheme and micro features of the avatars navigating the virtual space, such as a styleGAN generator that uses the intermediate vector in each level of a synthesis network) to overlay pixel information over the avatar such that an outfit fits the avatar as the avatar navigates the virtual space.

In some embodiments, the learning module 214 is configured to learn (e.g., via reinforcement learning) from observations of the avatar and the interactions within the metaverse to improve the behavior of the initiation module 206, the observation module 208, the intent prediction module 210, and/or the feature morphing module 212. For example, the learning module 214 can be configured to leverage dynamic feedback from the user to alter one or more aspects of the hyper-personalized feature morphing system 202. For example, user feedback (express or implied) can be used to change the behavior of the initiation module 206, the observation module 208, the intent prediction module 210, and/or the feature morphing module 212.

In some embodiments, user feedback includes user actions taken prior to or following an action of the hyper-personalized feature morphing system 202. For example, consider a scenario where the feature morphing module 212 dynamically changes an outfit of an avatar to a suit prior to an imminent (as predicted by the intent prediction module 210) interaction with a potential employer. Consider further the user manually changing the outfit, after the dynamic feature morphing, to a less formal shirt and jeans. In that scenario, the learning module 214 can record the manual override of the feature morphing module 212 and the current context (e.g., an anticipated interview with a particular company, etc.) as a data point for future use (e.g., as an input having significant weight to the learning module 214). In this manner, user feedback, express or otherwise, can be looped back as new inputs to the learning module 214.

In some embodiments, the learning module 214 is configured to learn (via setting, e.g., internal weights in one or more hidden layers of a neural network) predictive interactions and engagement levels based on user's pattern history (interaction history).

In some embodiments, the learning module 214 is configured for reinforcement learning, where reward and penalty strategies are used in combination with user feedback to tune the feature morphing of the user's avatar. In some embodiments, the learning module 214 stores a pattern history, including past interactions and outcomes (e.g., user feedback, positive or negative), and uses the pattern history to tune predictions of users' potential engagements and the selection of appropriate features for feature morphing.

In some embodiments, the learning module 214 is configured to dynamically morph two or more sets of features into an overall hyper-personalization of the avatar. For example, the learning module 214 can be configured to blend a first set of features determined via accessing the user's pattern history (e.g., the appearance, apparels, and avatar styles stored in a cloud database and/or the personalization file 218) with a second set of features determined via learned affinities and preferences specific to a particular upcoming interaction (e.g., a particular booth, other avatar, etc.). For example, a dynamic morphing in the overall styling of an avatar can be achieved by mesh or pixel morphing a nameplate or label, such as a sticker that says “Alice” (e.g., a first set of features) over a suit and tie (e.g., a second set of features).

While discussed in the context of dynamic user feedback, the particular means of achieving a reward-based reinforcement learning strategy is not meant to be particularly limited. In some embodiments, the learning module 214 is configured to collect information about the user, the avatar, and/or the environment by monitoring user actions and/or avatar interactions within the metaverse. Using reinforcement learning, the learning module 214 can deploy various reward-based strategies in the virtual environment E as the avatar navigates the metaverse, for example, by monitoring every frame buffer update (e.g., or every N frames, etc.) provided to the user. Information can be tagged to coordinates (e.g., E′,x′,y′) that can be fed to a reinforcement learning gradient function. Reinforcement learning can be used within an overall feedback system, with trial and error of the attire (or other features) tuned over time by positive and negative reinforcement. For example, a positive sentiment identified with a user's heuristics (e.g., inferred by the user maintaining the hyper-personalization selected for the avatar for a particular interaction by the feature morphing module 212) can be provided back to the model as a reward “+x” that modifies the weights associated with the underlying intent and/or feature morphing recommendations provided via the learning model. Conversely, negative sentiment (captured explicitly or inferred by the user changing or undoing a hyper-personalization or by observing, via the observation module 208, a negative sentiment towards the user and/or avatar captured during one or more interactions) can be provided back to the model as a penalty “−x” that modifies the weights associated with the underlying intent and/or feature morphing recommendations provided via the learning model.

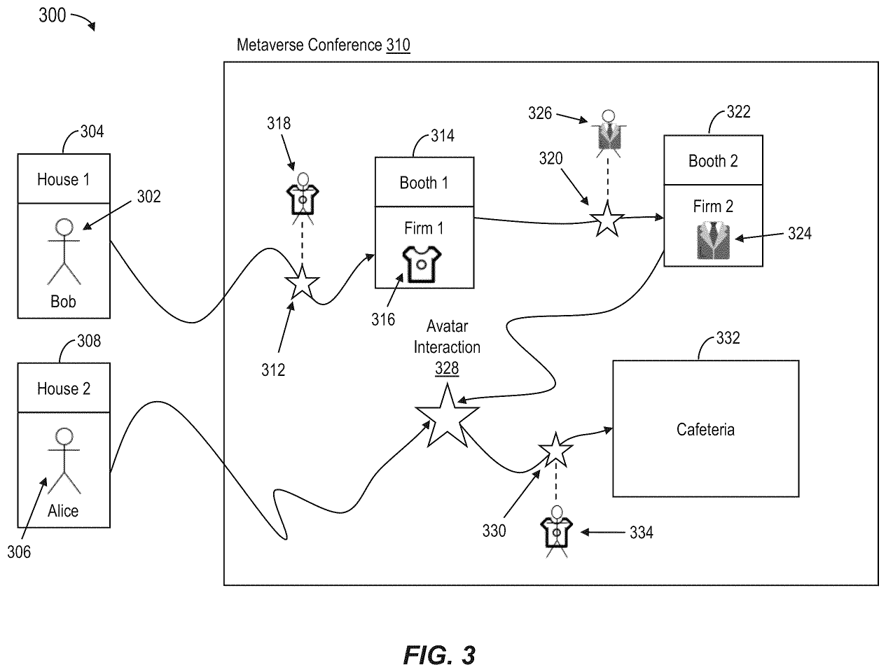

Referring now to FIG. 3, an example representation 300 illustrates dynamic hyper-personalized feature morphing in accordance with one or more embodiments of the present invention. As shown in FIG. 3, a first avatar 302 (here, “Bob”) is currently positioned within a first metaverse region 304. The first metaverse region 304 can include, for example, a default loading zone (login zone) for a user of the first avatar 302 upon entering a metaverse (here, “House 1”) or simply the current location of the first avatar 302 within the metaverse. Similarly, a second avatar 306 (here, “Alice”) is currently positioned within a second metaverse region 308 (here, “House 2”).

In some embodiments, the first avatar 302 leaves the first metaverse region 304 and enters a new region, for example, a metaverse conference 310. It should be understood that the metaverse conference 310 is provided for illustration purposes only and that the nature and/or scope of metaverse regions is not meant to be particularly limited. In particular, the new region need not be a virtual conference and can include any manner of events and/or activities of interest to a user.

While travelling through the metaverse conference 310, a hyper-personalized feature morphing system (e.g., the hyper-personalized feature morphing system 202 of FIG. 2) makes a prediction 312 (via, e.g., the intent prediction module 210) that the first avatar 302 will soon visit a first conference space 314 (here, “Booth 1” for “Firm 1”). In some embodiments, the conference space 314 (or specifically, Booth 1 and/or Firm 1) is associated with a set of known or learned features 316 (here, a casual shirt). In some embodiments, the hyper-personalized feature morphing system merges the set of features 316 with one or more current features of the first avatar 302 to create a hyper-personalization 318. For example, a casual shirt can be imposed via, for example, feature morphing according to one or more embodiments on or over the first avatar 302.

After visiting the first conference space 314, the first avatar 302 leaves and continues travelling through the metaverse conference 310. At some point, the hyper-personalized feature morphing system makes a prediction 320 that the first avatar 302 will soon visit a second conference space 322 (here, “Booth 2” for “Firm 2”). In some embodiments, the conference space 322 (or specifically, Booth 2 and/or Firm 2) is associated with a set of known or learned features 324 (here, a formal suit). For example, the hyper-personalized feature morphing system can learn via a natural language analysis of the respective user's social media, email, calendar, etc., that the first avatar 302 has an interview with one or more individuals at the second conference space 322. In some embodiments, the hyper-personalized feature morphing system merges the set of features 324 with the current features of the first avatar 302 (i.e., the features 316 and any previously existing features) to create a hyper-personalization 326. For example, a formal suit can be imposed over the casual shirt via, for example, feature morphing according to one or more embodiments.

After visiting the second conference space 322, the first avatar 302 leaves and continues travelling through the metaverse conference 310. At some point, the hyper-personalized feature morphing system has an avatar interaction 328 with another avatar (here, the second avatar 306 for “Alice”). In some embodiments, a new hyper-personalization (not separately shown) can be generated for the first avatar 302 responsive to the avatar interaction 328 (or a prediction for the avatar interaction 328).

The first avatar 302 and the second avatar 306 continue travelling through the metaverse conference 310 together. Eventually, the hyper-personalized feature morphing system makes a prediction 330 that the first avatar 302 and the second avatar 306 will soon visit a third conference space 332 (here, the “Cafeteria”). In some embodiments, a new hyper-personalization 334 can be generated for the first avatar 302 responsive to the prediction 330 in a similar manner as described previously with respect to other feature morphing operations. For example, the formal suit from features 324 can be removed from the first avatar 302 or, alternatively, a new set of features (e.g., another casual outfit) can be applied to the first avatar 302 over the formal suit.

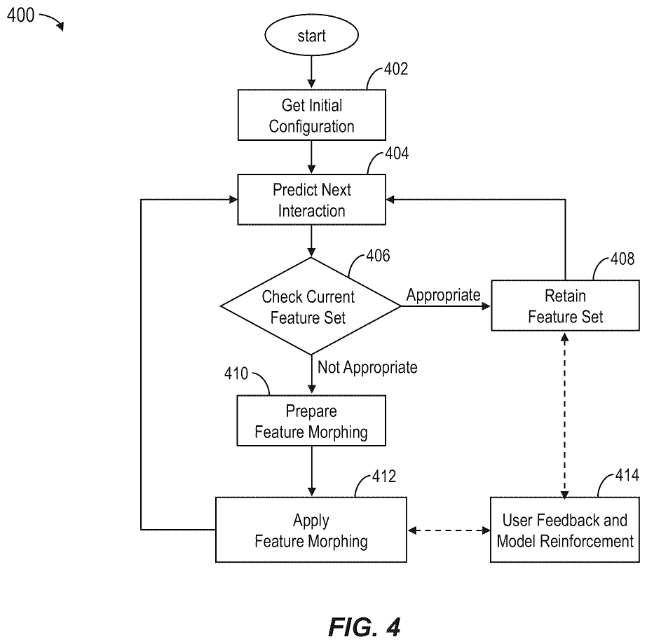

FIG. 4 depicts a block diagram 400 for hyper-personalizing an avatar (via, e.g., feature morphing) in accordance with one or more embodiments of the present invention. As shown in FIG. 4, an initial configuration (set of default or current features) for an avatar is received at block 402. The initial configuration can be retrieved from, for example, the personalization file 218 of FIG. 2.

At block 404, a next interaction is predicted according to one or more embodiments. For example, the next interaction can include an avatar-to-avatar interaction, an object interaction, an event or location interaction, etc., as described previously.

At block 406, the current feature set is checked to determine whether the current feature set is appropriate for the predicted next interaction according to one or more embodiments. In some embodiments, feature requirements for the predicted next interaction are compared against the current feature set. The feature requirements can be predetermined and/or learned in accordance with one or more embodiments (via, e.g., the software applications 204 and the personalization file 218 of FIG. 2).

If the current feature set is appropriate, the current feature set is retained at block 408. If the current feature set is not appropriate, a hyper-personalized feature morphing (e.g., hyper-personalization) for the avatar is prepared at block 410 in accordance with one or more embodiments.

At block 412 the hyper-personalization is applied to the avatar according to one or more embodiments. For example, one or more new features can be applied via feature morphing to the avatar upon a triggering event, such as, for example, when the avatar moves within a predetermined or learned proximity of the location of the predicted next interaction (e.g., a virtual conference booth, a virtual cafeteria, a virtual boardroom, a virtual home or region belonging to one or more other users, etc.). Triggering events are not meant to be particularly limited and other triggering events are possible. For example only, triggering events can be event-based, such as leaving the current region and/or interaction, can be time-based (e.g., feature morphing applies at predetermined or learned times within the metaverse and/or the real world), etc.

After the hyper-personalization is applied to the avatar, feedback (whether express, implicit, and/or implied) is obtained from the user of the avatar and/or from interactions within the metaverse at block 414 in accordance with one or more embodiments. In some embodiments, the feedback can be provided back to a learning model as reinforcement data (e.g., rewards and penalties) as described previously.

FIG. 5 depicts a diagram 500 for determining geospatial distancing within a metaverse in accordance with one or more embodiments of the present invention. As shown in FIG. 5, a metaverse space 502 can include an avatar 504 and one or more interactable entities 506 (e.g., objects, other avatars, locations, points of interest, etc.). In some embodiments, a hyper-personalized feature morphing system (e.g., the hyper-personalized feature morphing system 202 of FIG. 2) begins making predictions (via, e.g., the intent prediction module 210) for future interactions of the avatar 504 with one or more of the interactable entities 506 in accordance with one or more embodiments.

In some embodiments, the predictions are based in whole or in part on a geospatial distance between the avatar 504 and one or more of the interactable entities 506. In some embodiments, the hyper-personalized feature morphing system 202 calculates a Euclidean metric (distance) between the avatar 504 and one or more (e.g., all) of the interactable entities 506 within a distance space 508. For example, a current location of the avatar 504 can be determined against a fixed or local coordinate system (here, the coordinates [x₁, y₁, z₁]). Similarly, a current location of each of the interactable entities 506 (here, interactable entity 506a) can be determined against the fixed or local coordinate system (here, the coordinates [x₂, y₂, z₂]). The distance “D” can then be determined using Euclidean metrics, for example in two dimensions: d(x,y)=sqrt(Σᵢ₌₀^{k}(Xi−Yi)²).

In some embodiments, distance calculations leverage distance-based clustering techniques in which multi-hop, multi-level forwarding is combined with Euclidean distance-based criteria for predictions. For example, the hyper-personalized feature morphing system 202 can leverage known approximate rank-order clustering algorithms and, in each cluster, a Euclidean distance can be calculated. In other words, a Euclidean distance-based clustering approach.

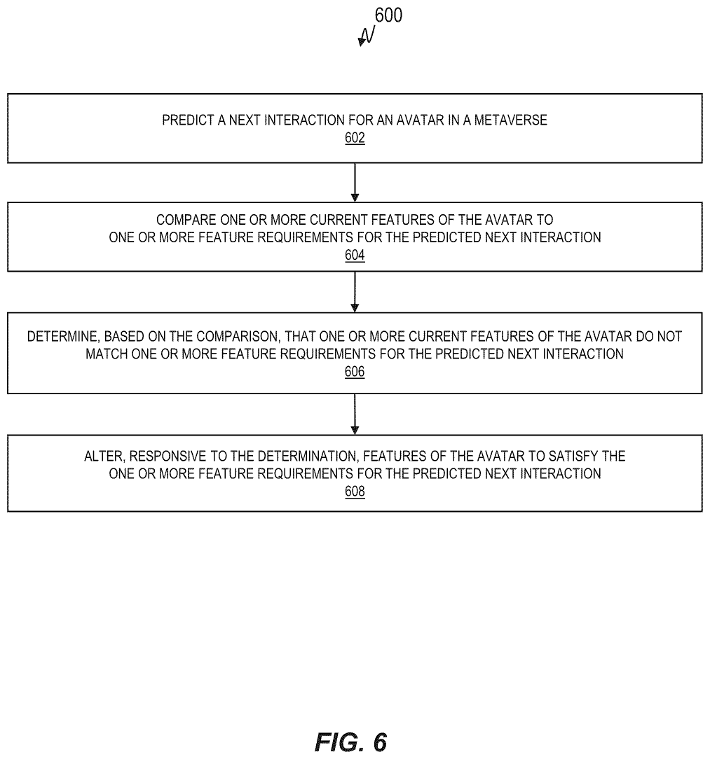

Referring now to FIG. 6, a flowchart 600 for hyper-personalizing an avatar is generally shown according to an embodiment. The flowchart 600 is described in reference to FIGS. 1-5 and may include additional blocks not depicted in FIG. 6. Although depicted in a particular order, the blocks depicted in FIG. 6 can be rearranged, subdivided, and/or combined.

At block 602, a next interaction for an avatar in a metaverse is predicted. In some embodiments, predicting the next interaction includes determining an intent of the avatar based on one or more of a current gaze direction, a current gaze duration, a proximity to a possible interaction, a trajectory relative to the possible interaction, an expected interaction for the avatar, learned behavior of a user of the avatar, and mined data about one or more of the user and the possible interaction. In some embodiments, mined data includes data collected from one or more of an email, social media platform, and a calendar of the user.

At block 604, one or more current features of the avatar are compared to one or more feature requirements for the predicted next interaction. At block 606, it is determined, based on the comparison, that one or more current features of the avatar do not match one or more feature requirements for the predicted next interaction.

At block 608, responsive to the determination, features of the avatar are altered to satisfy the one or more feature requirements for the predicted next interaction. In some embodiments, altering the features of the avatar includes feature morphing according to one or more embodiments. In some embodiments, feature morphing comprises pixel merging or mesh merging at least one of an outfit or an accessory with the one or more current features of the avatar.

In some embodiments, altering the features further includes preparing one or more new features for the avatar, waiting for a triggering event, and applying, responsive to the triggering event occurring, the one or more new features to the avatar. In some embodiments, the triggering event is one of a predetermined proximity to the predicted next interaction and a predetermined proximity from a prior interaction.

Technical advantages and benefits include automated hyper-personalized feature morphing of a user's avatar within a metaverse. Automating and streamlining the personalization of avatars creates a more natural, engaging virtual experience. Continuing with an earlier example, consider a virtual, multi-day conference. According to aspects of the present disclosure, a user can, prior to attending the virtual event, customize some initial preferences regarding their avatar, such as their avatar's attire. In some embodiments, the user can also select some preferred outfit or look for one or more specific events or interactions within the virtual event. For example, the user can select a particular outfit or a type of attire (formal, casual, etc.) for an upcoming interview. In some embodiments, hyper-personalized feature morphing can be triggered in response to rules and/or preferences, such as by as current or anticipated engagement with a particular avatar(s), object(s), and/or virtual event(s). Anticipated engagements can be determined using a variety of techniques (gaze detection, trajectory/movement/direction, etc.). In some embodiments, hyper-personalized feature morphing can be leveraged to dynamically alter an avatar in response to the avatar's location (or interaction) or anticipated location (or interaction). In some embodiments, the avatar's location and trajectory within the metaverse can be tracked and compared against the locations of one or more other avatars, events, and/or objects to determine an interaction probability between the avatar and the other avatar, event, and/or object. In some embodiments, one or more features of the user's avatar can be dynamically changed (referred to herein as hyper-personalized feature morphing) when the interaction probability is greater than a predetermined threshold. For example, in some cases, hyper-personalized feature morphing can be applied to an avatar based on the current proximity to the other avatar, event, and/or object.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

One or more of the methods described herein can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description, but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method comprising:
predicting a next interaction for an avatar in a metaverse;
comparing one or more current features of the avatar to one or more feature requirements for the predicted next interaction;
determining, based on the comparison, that one or more current features of the avatar do not match one or more feature requirements for the predicted next interaction; and
altering, responsive to the determination, features of the avatar to satisfy the one or more feature requirements for the predicted next interaction.

2. The computer-implemented method of claim 1, wherein predicting the next interaction comprises determining an intent of the avatar based on one or more of a current gaze direction, a current gaze duration, a proximity to a possible interaction, a trajectory relative to the possible interaction, an expected interaction for the avatar, learned behavior of a user of the avatar, and mined data about one or more of the user and the possible interaction.

3. The computer-implemented method of claim 2, wherein mined data comprises data collected from one or more of an email, social media platform, and a calendar of the user.

4. The computer-implemented method of claim 1, wherein altering the features of the avatar includes feature morphing.

5. The computer-implemented method of claim 4, wherein feature morphing comprises pixel merging or mesh merging at least one of an outfit or an accessory with the one or more current features of the avatar.

6. The computer-implemented method of claim 4, wherein altering the features further comprises:
preparing one or more new features for the avatar;
waiting for a triggering event; and
applying, responsive to the triggering event occurring, the one or more new features to the avatar.

7. The computer-implemented method of claim 6, wherein the triggering event is one of a predetermined proximity to the predicted next interaction and a predetermined proximity from a prior interaction.

8. A system having a memory, computer readable instructions, and one or more processors for executing the computer readable instructions, the computer readable instructions controlling the one or more processors to perform operations comprising:
predicting a next interaction for an avatar in a metaverse;
comparing one or more current features of the avatar to one or more feature requirements for the predicted next interaction;
determining, based on the comparison, that one or more current features of the avatar do not match one or more feature requirements for the predicted next interaction; and
altering, responsive to the determination, features of the avatar to satisfy the one or more feature requirements for the predicted next interaction.

9. The system of claim 8, wherein predicting the next interaction comprises determining an intent of the avatar based on one or more of a current gaze direction, a current gaze duration, a proximity to a possible interaction, a trajectory relative to the possible interaction, an expected interaction for the avatar, learned behavior of a user of the avatar, and mined data about one or more of the user and the possible interaction.

10. The system of claim 9, wherein mined data comprises data collected from one or more of an email, social media platform, and a calendar of the user.

11. The system of claim 8, wherein altering the features of the avatar includes feature morphing.

12. The system of claim 11, wherein feature morphing comprises pixel merging or mesh merging at least one of an outfit or an accessory with the one or more current features of the avatar.

13. The system of claim 11, wherein altering the features further comprises:
preparing one or more new features for the avatar;
waiting for a triggering event; and
applying, responsive to the triggering event occurring, the one or more new features to the avatar.

14. The system of claim 13, wherein the triggering event is one of a predetermined proximity to the predicted next interaction and a predetermined proximity from a prior interaction.

15. A computer program product comprising a computer readable storage medium having program instructions embodied therewith, the program instructions executable by one or more processors to cause the one or more processors to perform operations comprising:
predicting a next interaction for an avatar in a metaverse;
comparing one or more current features of the avatar to one or more feature requirements for the predicted next interaction;
determining, based on the comparison, that one or more current features of the avatar do not match one or more feature requirements for the predicted next interaction; and
altering, responsive to the determination, features of the avatar to satisfy the one or more feature requirements for the predicted next interaction.

16. The computer program product of claim 15, wherein predicting the next interaction comprises determining an intent of the avatar based on one or more of a current gaze direction, a current gaze duration, a proximity to a possible interaction, a trajectory relative to the possible interaction, an expected interaction for the avatar, learned behavior of a user of the avatar, and mined data about one or more of the user and the possible interaction.

17. The computer program product of claim 16, wherein mined data comprises data collected from one or more of an email, social media platform, and a calendar of the user.

18. The computer program product of claim 15, wherein altering the features of the avatar includes feature morphing.

19. The computer program product of claim 18, wherein feature morphing comprises pixel merging or mesh merging at least one of an outfit or an accessory with the one or more current features of the avatar.

20. The computer program product of claim 18, wherein altering the features further comprises:
preparing one or more new features for the avatar;
waiting for a triggering event; and
applying, responsive to the triggering event occurring, the one or more new features to the avatar.
